(19) United States
(12) Patent Application Publication
(10) Pub. No.: US 2013/0262484 A1
(43) Pub. Date: Oct. 3, 2013

(54) METHOD AND SYSTEM FOR MANAGING PRODUCT REGULATIONS AND STANDARDS

(71) Applicant: BUREAU VERITAS, Neuilly sur Seine (FR)

(72) Inventors: Rohit Kamat, Hong Kong (HK); Tim Mattulke, Buffalo, NY (US)

(73) Assignee: Bureau Veritas, Neuilly sur Seine (FR)

(21) Appl. No.: 13/844,135

(22) Filed: Mar. 15, 2013

Related U.S. Application Data
(60) Provisional application No. 61/619,442, filed on Apr. 3, 2012.

(51) Int. Cl. G06F 17/30

(52) U.S. Cl. CPC G06F 17/30699
USPC 707/754

(57) ABSTRACT

A product regulations and standards management system for filtering, organizing, and generating from product regulations and standards raw data, collected from various governments, regulatory authorities, or trade associations, a plurality of different types of reports organized by the characteristics of the information recorded in the reports, wherein the characteristics include, but not limited to, granularity of the information, product/service lines covered by the information, publication time of the information, effective time period of the information, economic and geographical locations covered by the information. The different types of reports comprise a Basic Summary, a Simple Specification, a Complex Specification, and a Product Guideline.

### CLAIM FOR DOMESTIC PRIORITY

This application claims priority under 35 U.S.C. §119 to the U.S. Provisional Utility Patent Application No. 61/619,442, filed Apr. 3, 2012, and the disclosure of which is incorporated herein by reference in its entirety.

### FIELD OF THE INVENTION

The present invention relates generally to information systems used in product manufacturing, testing, quality control, quality assurance, logistics, and safety and regulation compliance certification processes. Particularly, the present invention relates to methods and systems for managing, collecting, and presenting data pertaining to product regulations and standards.

### BACKGROUND

To achieve scale of economy and cost efficiency, finished goods are often marketed, sold, and used in more than one economic or geographical market without extensive redesign for each market. This means that the goods must be designed to meet diverse sets of regulatory requirements in multiple jurisdictions at the time when the goods are imported into these markets. For example, a mobile communication device being sold in the United States and the European Union might have to meet the regulatory requirements set out by the Federal Communications Commission (FCC) in the U.S., the U.S. Consumer Product Safety Improvement Act (CPSIA), the Waste Electrical and Electronic Equipment Directive (WEEE) and the Restriction of Hazardous Substances Directive (RoHS) in the European Union. In addition, modern product manufacturing supply chains can span across multiple countries. This means all components that are sourced from different countries must also be designed and manufactured to meet these regulatory requirements. Therefore, there is a need for a tool or a method that can constantly monitor, gather, and sort through all relevant information regarding the laws, regulations, and standards governing the products to be sold in the jurisdictions of concern.

### SUMMARY

It is an objective of the presently claimed invention to provide a method and system that collect, manage, and present in a plurality of different formats up-to-date data of product regulations and standards in multiple jurisdictions. Such method and system can be an integral part of product manufacturing, logistic, and/or quality control and assurance processes.

It is a further objective to provide such method and system that can filter, organize, and generate from the collected product regulations and standards raw data a plurality of different types of reports organized by the characteristics of the information recorded in the reports, wherein the characteristics include, but not limited to, the granularity of the information, the product/service lines covered by the information, the publication time of the information, the effective time period of the information, the economic and geographical locations covered by the information.

The types of reports can be a Basic Summary, a Simple Specification, a Complex Specification, and/or a Product Guideline.

### BRIEF DESCRIPTION OF THE DRAWINGS

Embodiments of the invention are described in more detail hereinafter with reference to the drawings, in which

FIG. 1 shows a diagram illustrating the possible compositions of information in Simple Specification, Complex Specification, and Product Guideline product regulations and standards reports;

FIG. 2 shows a diagram illustrating the Parent-Child Relationships among product regulations and standards reports;

FIG. 3 shows another diagram illustrating the Parent-Child Relationships among product regulations and standards reports; and

FIG. 4 shows a diagram illustrating an exemplary embodiment of the user interface showing the relationships of a report in a tabular representation.

### DETAILED DESCRIPTION

In the following description, methods and systems managing, collecting, and presenting data pertaining to product regulations and standards and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance to various embodiments, a user of the presently claimed product regulations and standards management system, through the use of a client computing device, makes requests for the presentment of product regulations and standards to a server application running in a processing server or cluster of processing servers to be displayed on the client computing device. The client computing device can be a conventional general purpose desktop or mobile computer, personal digital assistant, smart mobile phone, or any computing device with graphics display capability and is capable of processing computer data signals conforming to common data transmission protocols such as TCP/IP, HTTP, and HTML. The requests and responses between the client computing device and the processing server or cluster of processing servers is transmitted through wired and/or wireless communication medium. One such communication medium is the Internet. The server application running at the processing server or cluster of processing servers collects from other internal and/or external processing servers for product regulations and standards raw data and preserves these raw data in a data repository, which can be residing in one or more of the processing server or cluster of processing servers or a separate processing server or cluster of processing servers. The user interacts with the client computing device through a user interface of the product regulations and standards management system. In accordance to various embodiments, such user interface can be an Internet browser application or a custom application running in the client computing device displaying one or more web applications or web pages hosted and executed by the processing server or cluster of processing servers.

In accordance to various embodiments, the product regulations and standards management system filters, organizes, and generates from the collected product regulations and standards raw data a plurality of different types of reports organized by the characteristics of the information recorded in the reports, wherein the characteristics include, but not limited to, granularity of the information, product/service lines covered by the information, publication time of the information, effective time period of the information, economic and geographical locations covered by the information. The different types of reports comprise a Basic Summary, a Simple Specification, a Complex Specification, and a Product Guideline.

In accordance to one embodiment, a Basic Summary of product regulations and standards records at least one of the following information:

1.) Policies, Guidance Documents, or Notices: which are information related to policies published by governments, regulatory authorities, or trade associations;

2.) News, Meeting Notes, or Discussions: which are information regarding news, appointments, banning of products, and workshops related to regulations and standards;

3.) Recalls: which are information related to product recalls conducted by companies as voluntary recalls, or mandatory recalls enforced by governing bodies;

4.) Bill, Act, or Regulation Proposals or Reviews: which are information related to bills that are being proposed in legislature, existing laws, rules or regulations that are being discussed for review, revisions of existing laws, rules or regulations, and new laws, rules or regulations expected to be made effective in the future; and

5.) Standard Proposals or Reviews: which are information related to existing standards that are being discussed for review, revisions of existing standards, and new standards expected to be published in future.

The Basic Summaries of product regulations and standards are in the form of technical updates related to the aforementioned categories of information, which are generally published before the actual promulgation of an act, rule, regulation, standard, or any amendment thereof

In accordance to another embodiment, a Simple Specification of product regulations and standards records at least one of the following information:

1.) Acts: which are laws enacted by the parliaments, senates, congress, or other government bodies; most of these acts are results of bills passed through legislation, but in some countries these acts are directly enacted by the governments;

2.) Regulations: which are new rules, regulations, and/or amendments to existing rules or regulations published and enforced by regulatory authorities;

3.) Standards: which are new standards and/or amendments to existing standards published by standard-setting organizations; and

4.) Policies, Guidance Documents, or Notices: which are information related to policies published by governments, regulatory authorities, or trade associations;

The Simple Specification of product regulations and standards are updated when there are actual promulgations of an act, rule, regulation, standard, or any amendment thereof

In accordance to another embodiment, a Complex Specification of product regulations and standards provides information that is a combination of one or more Simple Specifications of product regulations and standards for a certain defined objective. For example, a Complex Specification can be a combination of Policies, Guidance documents, Notices Acts, Regulations, and/or Standards showing the detail information for a product designed to meet the Consumer Product Safety Improvement Act (CPSIA) compliance requirements.

In accordance to another embodiment, a Product Guideline provides information regarding a specific product category for a specific country, which can be a combination of one or more Simple Specifications and/or Complex Specifications.

Each product regulations and standards report of each type as described above can draw its data input from a master data repository, which is an aggregation of all source information made available by government agencies, trade associations, and other publishers in each country covered by the reports.

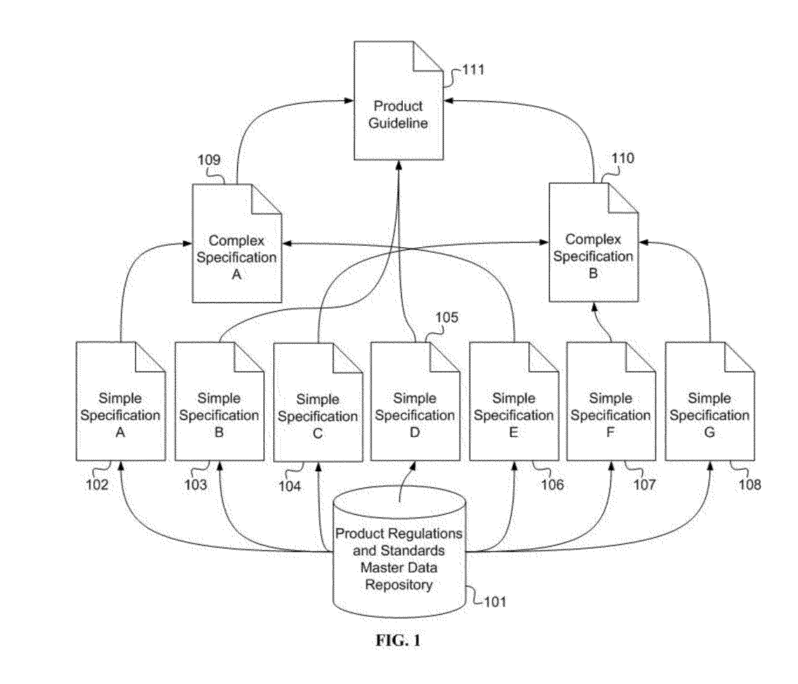

FIG. 1 illustrates the possible compositions of information in a Simple Specification, a Complex Specification, and a Product Guideline. Each of Simple Specifications A-G (102-108) compiles its information from the master data repository 101. Complex Specification A 109 comprises information in Simple Specification A 102 and Simple Specification E 106. Complex Specification B 110 comprises information in Simple Specification C 104, Simple Specification F 107, and

Simple Specification G 108. Product Guideline 111 comprises information in Simple Specification B 103, Simple Specification D 105, Complex Specification A 109, and Complex Specification B 110.

Each abovementioned product regulations and standards report of each type or its subsequent update has an author, a reviewer, and an approver. An author creates a report or an update of an existing report through the user interface of the product regulations and standards management system. The system allows pre-defined reviewers and approvers to be assigned for each report type. The system also allows the authors to assign, during runtime, other users, including the authors themselves, to be the reviewers and approvers for certain report types and for certain reports in the user interface of the product regulations and standards management system. Upon the creation of a report by the author, the assigned reviewer will receive a notification communication, for example: an email, from the product regulations and standards management system. The reviewer, through the user interface of the product regulations and standards management system, reviews the newly created report or update. Upon the completion of the review, the product regulations and standards management system sends a notification communication to the assigned approver requesting her approval at the user interface of the product regulations and standards management system. Upon approval, the newly created report or update is published and made available for search and retrieval by other users of the product regulations and standards management system.

A user of the product regulations and standards management system can view all reports available in the system in a “view all” mode through its user interface. A user can also select those of interest from all available reports and save into a portfolio—“my reports”. Under either “view all” or “my reports” mode, the reports to be retrieved and displayed can be filtered by one or more of the following data fields: Product/Service Line, Product Category, Record (Report) Type, Content Type, Geographic Region, Economic Region, Country, State/Province, City/County, and Date Range. The user can also specify a limit to the number of records (reports) to be retrieved and displayed.

A view of reports can vary based on the type of reports retrieved and displayed. In accordance to an exemplary embodiment, a view of Basic Summaries will display in each report item the Title of the Basic Summary, a pre-defined portion of the content of the report, the Product/Service Line specified in the report, the Economic Region and Country specified in the report, and the Record (Report) Type. A view of Simple Specifications will display in each report item the Title of the Simple Specification, a pre-defined portion of the content of the report, the Product/Service Line specified in the report, the Economic Region and Country specified in the report, and the Record (Report) Type. A view of Complex Specifications will display in each report item the Title of the Complex Specification, a pre-defined portion of the Introduction of the report, the Product/Service Line specified in the report, the Economic Region and Country specified in the report, and the Record (Report) Type. A view of Product Guidelines will display in each report item the Title of the Product Guideline, a pre-defined portion of the Introduction of the report, the Product/Service Line specified in the report, the Economic Region and Country specified in the report, and the Record (Report) Type.

The retrieval of specific reports can be accomplished by searches. A user can conduct a parametric keyword search using the product regulations and standards management system user interface by specifying one or more values for one or more of the following data fields: Record (Report) Title, Record (Report) Type, Product/Service Line, Geographic Region, Economic Region, Country, Act/Regulation/Standard Number, Act/Regulation/Standard Title, Source Agency, Reference Number, Publication Date Range, Specification Classification, Specification Requirement Type, Resource Language, Keyword, Parent-Child Relationships, Material, Author, Effective Date Range, and Withdrawn Date Range. Search query strings based on one or more abovementioned data fields can be formed using Boolean expressions. In addition, searches can be based on one or more of Chemical Taxonomy, Product Taxonomy, and Hazard Taxonomy.

Each product regulations and standards report can have corresponding updates whenever there is a published amendment to the information recorded in the report. When a user retrieves and views the report, its updates are also shown or at least indicated prominently on the user interface for the user to query and retrieve the reports on the updates. The user can also choose to be shown a specific or range of historical updates by specifying in the user interface a selection option from one of: Today, Last 7 days, Month to Date, Year to Date, The Previous Month, Specific Dates, All Dates Before, All Dates After, and Date Range.

In accordance to one embodiment, a Basic Summary can have one or more relationships with one or more other Basic Summaries. A relationship can be a Peer Connection or a Parent-Child Relationship. A Peer Connection exists where a Basic Summary of a Policies, Guidance Documents, or Notices item, a News, Meeting Notes, or Discussions item, or a Recall is related to another Basic Summary. A Peer Connection also exists between a Bill as recorded in one Basic Summary that is related to another Bill as recorded in another Basic Summary; between an Act as recorded in one Basic Summary that is related to another Act as recorded in another Basic Summary; between a Rule or Regulation as recorded in one Basic Summary that is related to another Rule or Regulation as recorded in another Basic Summary; and between a Standard as recorded in one Basic Summary that is related to another Standard as recorded in another Basic Summary. A Parent-Child Relationship exists where a proposed Bill as recorded one Basic Summary is being passed and become an Act as recorded in another Basic Summary; where an Act as recorded in one Basic Summary is being implemented as a Rule or Regulation as recorded in another Basic Summary; or where an Act, and/or a Rule or Regulation as recorded in one Basic Summary is being further implemented as a Standard as recorded in another Basic Summary.

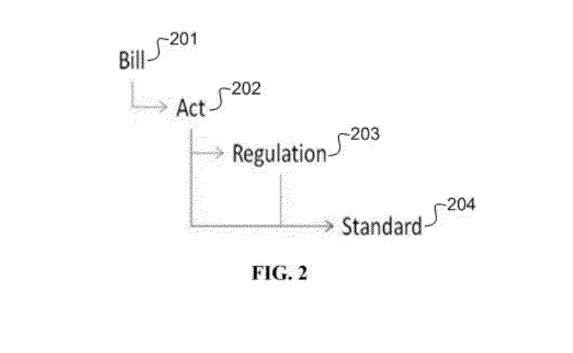

Multiple Parent-Child Relationships can also form a chain of Parent-Child Relationships as illustrated in FIG. 2. Bill 201 is the Parent of Act 202; Act 202 is the Child of Bill 201 and also the Parent of Regulation 203 and Standard 204; and Regulation 203 can also be the Parent of Standard 204 as well. In this case, Standard 204 as a Child has two Parents - Regulation 203 and Standard 204.

An update to a Basic Summary, such as an amendment to a Bill, an Act, or a Rule or Regulation recorded in the Basic Summary is a Child to the Bill, Act, Rule or Regulation in a Child-Parent Relationship.

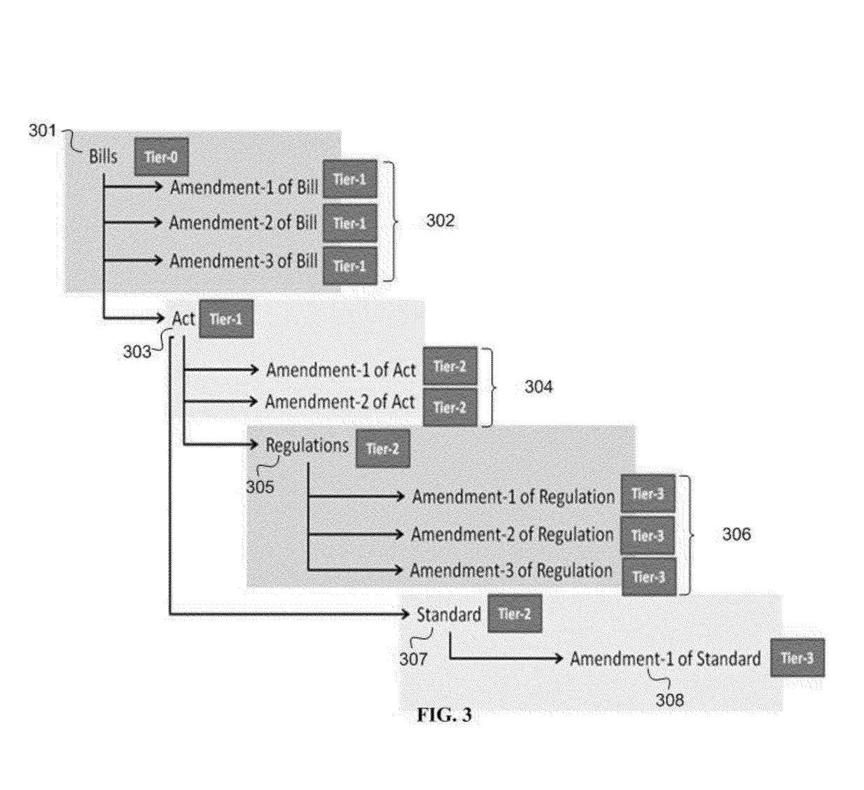

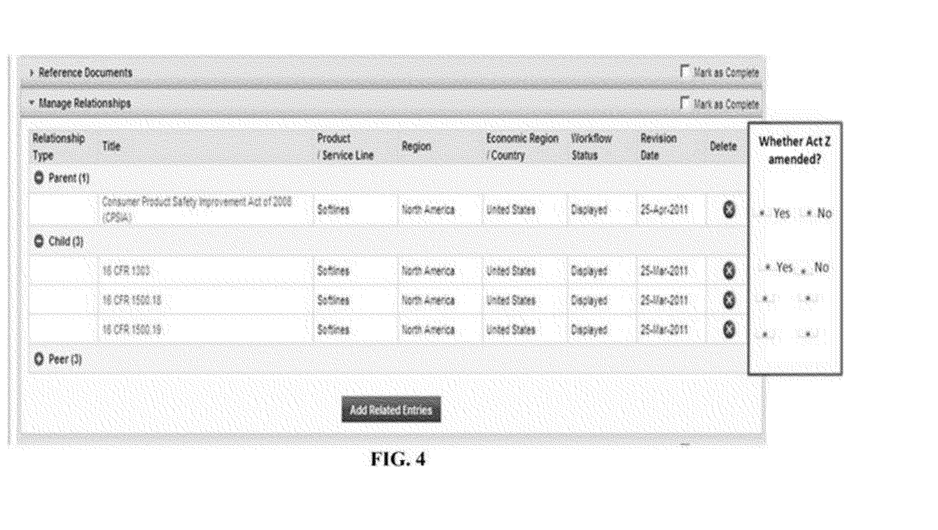

Multiple Parent-Child Relationships or a chain of Parent-Child Relationships can have one or more tiers. Illustrated in FIG. 3 as an example, for Bills 301, its tier-1 Children are: Amendments of Bill 302 and Act 303; its tier-2 Children are: Amendments of Act 304, Regulations 305, and Standard 307; and tier-3 Children are: Amendments of Regulation 306 and Amendment of Standard 308. For Standard 306, its tier-1 Parent is Act 303; and its tier-2 Parent is Bills 301. In the product regulations and standards management system user interface, a user can select to display the relationships of a particular report. She can also specify the tier level to be shown. FIG. 4 illustrates an exemplary embodiment of the user interface showing the relationships of a report in a tabular representation. This view is structured to allow the user to view only one tier of Parents of a Basic Summary, one tier of Children of a Basic Summary, all Peers connected to a Basic Summary, or one tier of Parents and one tier of Children of a Basic Summary. By tracing through the relationships, the user can see all the changes that have been made to the information recorded in a report over time and how certain promulgation of laws, rules or regulations, and standards impact the information recorded in the report.

In accordance to one embodiment, a Basic Summary comprises the following data fields: Revision Date, Basic Summary Primary Reference Number, Basic Summary Title, Product/Service Line, Content Type, Geographic Region, Economic Region, Country, State/Province, City/County, Act/Regulation/Standard Number, Act/Regulation/Standard Title, Alternate Act/Regulation/Standard Title, Document Status, Summary, Source Agency, Document Published Date, Document URL Location, Document URL Name, Document Title (for attachments), Document Language (for attachments), Resource Language, Parent/Children Relations, Keywords, Author, Creation Date, Workflow Status, Reviewer, Approver, and Comment.

In accordance to one embodiment, a Basic Summary can have one or more linked Simple Specifications. A Simple Specification, however, can correspond only to one Basic Summary. After a user creates a Basic Summary using the user interface of the product regulations and standards management system, the user can create one or more Simple Specifications to be linked to the Basic Summary. Information in the Basic Summary can automatically propagate to the linked Simple Specifications created. When subsequent updates, such as amendments to an Act, a Rule or Regulation, are published to the information recorded in the Basic Summary, reports of the updates of the Basic Summary is created, similarly, reports of the updates of linked Simple Specifications are to be created as well and be linked to the reports of the updates of the Basic Summary. Peer Connections and Parent/Child Relations of the Basic Summary can similarly be formed between the Simple Specifications.

In accordance to one embodiment, a Simple Specification comprises the following data fields: Revision Date, Specification Primary Reference Number, Simple Specification Title, Product Taxonomy, Chemical Taxonomy, Hazard Taxonomy, Version Revision Number System, Version Revision Number, Introduction, Spec Title, Spec Classification, Spec Requirement Type, Applicability, Purpose, Highlights, Exemptions (yes/no), Exemption Details, Document Title (for attachments), Document Language (for attachments), Image Name, Image Summary, Parent/Children Relations, Material, Effective Date, Withdrawn Date, Document URL Location, Document URL Name, Additional Document URLs, Comments, Document Published Date, Product/Service Line, Content Type, Geographic Region, Economic Region, Country, State/Province, City/County, Act/Regulation/Standard Number, Act/Regulation/Standard Title, Source Agency, Document Status, Creation Date, and Workflow Status.

In accordance to one embodiment, a Complex Specification is created by compiling information from a plurality of Simple Specifications. The compiled information is sorted based on one or more user-selected data fields of the Simple Specifications used to created the Complex Specification and indexed in a Table of Contents. In addition to the compiled information from the Simple Specifications, a Complex Specification comprises the following data fields: Revision Date, Complex Specification Primary Reference Number, Complex Specification Title, Product/Service line, Geographic Region, Economic Region, Country, State/Province, City/County, Version Revision Number System, Version Revision Number, Product Taxonomy, Hazard Taxonomy, Chemical Taxonomy, Table of Contents, Introduction, Spec Requirement Type, Document Title (for attachments), Document Language (for attachments), Image Name, Image Summary, Specification Reference, Notes, Comments, Applicability, Purpose, Highlights, Exemptions (yes/no), and Exemption Details.

In accordance to one embodiment, a Product Guideline is created by compiling information from a plurality of Simple Specifications and/or Complex Specifications. The compiled information is sorted based on one or more user-selected data fields of the Simple Specifications and/or Complex Specifications used to created the Product Guideline and indexed in a Table of Contents. In addition to the compiled information from the Simple Specifications and/or Complex Specifications, a Product Guideline comprises the following data fields: Revision Date, Complex Product Guideline Reference Number, Product Guideline Title, Product/Service line, Geographic Region, Economic Region/Country, State/Province, City/County, Version Revision Number System, Version Revision Number, Product Taxonomy, Hazard Taxonomy, Chemical Taxonomy, Table of Contents, Introduction, Document Title (for attachments), Document Language (for attachments), Image Name, Image Summary, Specification References, and Comments.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for managing product regulations and standards, comprising:
collecting, by a processing server, product regulations and standards raw data from one or more internal and/or external processing servers;
preserving, by a data repository, the collected product regulations and standards raw data;
filtering, organizing, and generating from, by the processing server, the collected product regulations and standards raw data one or more reports organized by characteristics of information recorded in the generated reports, wherein the characteristics comprising granularity of the information, product/service lines covered by the information, publication time of the information, effective time period of the information, economic and geographical locations covered by the information; and
presenting, by the processing server, the generated reports in a user interface to be displayed in a client computing device connected to the processing server.

2. The method of claim 1, wherein the generated reports being one of a basic summary, a simple specification, a complex specification, or a product guideline.

3. The method of claim 2, wherein the basic summary recording at least one of policies, guidance documents, or notices; news, meeting notes, or discussions; recalls; bill, act, or regulation proposals or reviews; and standard proposals or reviews.

4. The method of claim 2, wherein the simple specification recording at least one of acts; regulations; standards; and policies, guidance documents, or notices; news, meeting notes, or discussions; recalls; bill, act, or regulation proposals or reviews; and standards.

5. The method of claim 2, wherein the basic summary being linked with one or more simple specifications; and wherein information in the basic summary being propagated to the one or more linked simple specifications during creation.

6. The method of claim 2, wherein the complex specification recording a combination of information recorded in one or more simple specifications for a defined objective.

7. The method of claim 2, wherein the product guideline recording a combination of information recorded in one or more simple specifications and/or complex specifications regarding a specific product category for a specific country.

8. The method of claim 2, wherein the basic summary recording a plurality of data fields, wherein the data fields comprising: title, product/service line, geographic region, economic region, country, state/province, city/county, Act/regulation/standard number, Act/regulation/standard title, summary, source agency, document published date, author, and creation date.

9. The method of claim 2, wherein the simple specification recording a plurality of data fields, wherein the data fields comprising: title, product/service line, product taxonomy, chemical taxonomy, hazard taxonomy, geographic region, economic region, country, state/province, city/county, Act/regulation/standard number, Act/regulation/standard title, and introduction.

10. The method of claim 2, wherein the complex specification recording a plurality of data fields, wherein the data fields comprising: title, product/service line, product taxonomy, chemical taxonomy, hazard taxonomy, geographic region, economic region, country, state/province, city/county, Act/regulation/standard number, Act/regulation/standard title, introduction, applicability, purpose.

11. The method of claim 2, wherein the product guideline recording a plurality of data fields, wherein the data fields comprising: title, product/service line, product taxonomy, chemical taxonomy, hazard taxonomy, geographic region, economic region, country, state/province, city/county, Act/regulation/standard number, Act/regulation/standard title, introduction, applicability, purpose.

12. The method of claim 1, wherein the generated reports having corresponding one or more updates when one or more amendment to information recorded in the generated reports are published.

13. The method of claim 2, wherein the basic summary having one or more relationships each with one of other basic summaries.

14. The method of claim 12, wherein a relationship of the one or more relationships being a peer connection.

15. The method of claim 12, wherein a relationship of the one or more relationships being a parent-child relationship.
